(19) United States
(12) Patent Application Publication
(10) Pub. No.: US 2008/0213582 A1
(43) Pub. Date: Sep. 4, 2008

(54) Protective structure for attachment to a surface and method therefor

(76) Inventor: Dennis G. Schlisner, Dalton, GA (US)

Correspondence Address: LUEDEKA, NEELY & GRAHAM, P.C., P O BOX 1871, KNOXVILLE, TN, 37901, US

(21) Appl. No.: 12/024,810

(22) Filed: Feb. 1, 2008

Related U.S. Application Data
(60) Provisional application No. 60/887,782, filed on Feb. 1, 2007.

(51) Int. Cl. B32B 7/12; B32B 37/12

(52) U.S. Cl. 428/354; 428/343; 156/60

(57) ABSTRACT

Embodiments of the invention described herein include a protective structure for protecting a surface, the structure including a substantially planar polymeric member that is substantially free of dioctyl phthalate (DOP), whereby the protective structure more readily adheres to a separate surface. Another embodiment includes a method for attaching a protective structure to a surface, the method including the steps of providing a protective structure including a substantially planar polymeric member that is substantially free of dioctyl phthalate (DOP) and attaching the protective structure to a separate surface by use of an adhesive tape.

### CROSS REFERENCES TO RELATED APPLICATIONS

This application claims priority under 35 U.S.C. § 119(e) to provisional application Ser. No. 60/887,782, filed Feb. 1, 2007, which is incorporated by reference in its entirety herein.

### FIELD

This invention relates to the field of protective structures for protecting and/or decorating indoor surfaces including wall surfaces and methods for attaching such structures. More particularly, this invention relates to a wall base with physical properties that facilitate the adhesion of the wall base to a separate structure.

### BACKGROUND

Flooring wall base, which is sometimes referred to as cove base, is commonly provided by lengths of relatively rigid materials (e.g. wood) or flexible materials (e.g. flexible plastic, rubber, or strips of carpet) having widths of from about 3 to about 6 inches, most typically from about 3.5 to about 5 inches. Such wall bases are typically attached along the lowermost portions of a vertical wall adjacent the wall-floor intersection using fasteners such as nails or staples or an adhesive applied between the base and wall.

As discussed in U.S. Pat. No. 6,357,189 to Schlisner, the use of fasteners to secure flooring bases is undesirable in that installation of the base using fasteners is very laborious and time consuming, the fasteners can cause damage to the wall and base, and the fasteners often remain visible and detract from the appearance of the base requiring cosmetic measures to hide them from view. Successful attempts for limiting the need for such fasteners have been made using polyacrylic adhesive tape to adhere carpet wall bases to walls. However, the use of adhesive tape to adhere vinyl wall bases to walls or other similar structures has met with no long-term success. Previous efforts to use polyacrylic adhesive tape used in tandem with vinyl wall bases have resulted in generally poor adhesion and the bases tend to separate from the wall after a relatively short period of time.

Accordingly it is an object of the present invention to provide an improved vinyl wall base including an adhesive tape that better adheres to walls and other similar structures for the expected useful life of such vinyl wall base.

It is also an object of the present invention to provide a protective structure including a polymeric member with physical properties that allow the polymeric structure to more readily adhere to a surface that is to be protected or decorated.

Another object of the present invention is to provide a method for applying a protective structure (such as the protective structure and/or vinyl wall base described above) to a surface.

### SUMMARY

The above and other needs are met by a protective structure for protecting a surface, the protective structure comprising a substantially planar polymeric member wherein the polymeric member is substantially free from dioctyl phthalate (DOP). The protective structure preferably includes at least one strip of adhesive adhered to a backside surface of the polymeric member, the strip of adhesive for attaching the protective structure to a portion of one or more surfaces. Additionally, the protective structure is preferably in the form of a vinyl wall base. The polymeric member is preferably made of a material including a plasticizer including adipate-based plasticizers, trimellitates, maleates, sebacates, benzoates, epoxidized vegetable oils, sulfonamides, organophosphates, glycols, alkyl citrates, or a combination thereof.

Another embodiment of the present invention includes a method for protecting surfaces using a protective structure, the method including the steps of: (a) providing a protective structure including a substantially planar polymeric member that is substantially free from dioctyl phthalate (DOP); and (b) attaching the protective structure to a surface. In a related embodiment, the method includes a step of adjusting the size of the polymeric member, preferably by cutting the polymeric member to alter its length.

### BRIEF DESCRIPTION OF THE DRAWINGS

Further advantages of the invention are apparent by reference to the detailed description in conjunction with the figures, wherein elements are not to scale so as to more clearly show the details, wherein like reference numbers indicate like elements throughout the several views, and wherein:

FIG. 1 depicts an embodiment of a protective structure in the form of a vinyl wall base including a strip of adhesive tape, the protective structure shown as having been mounted on a wall surface:

FIG. 2 depicts an embodiment of a protective structure in the form of a vinyl wall base including two strips of adhesive tape, the protective structure shown having been mounted on a wall surface: and

FIG. 3 depicts a cutaway view of a protective structure in the form of vinyl wall base including an adhesive strip and a release liner strip.

### DETAILED DESCRIPTION

An unexpected and surprising discovery has recently been made with respect to the adhesive relationship between polyacrylic adhesive and protective structures such as vinyl wall bases. The cause of previous relatively poor adhesion between vinyl wall bases and polyacrylic adhesive is now believed to be due in large part to the plasticizer used in the vinyl wall base. The term “vinyl wall base” is commonly used in the art to refer to polymeric wall bases and most commonly to wall bases formed from PVC or other thermoplastic compounds. For the purposes of this disclosure, the term “vinyl wall base” is defined broadly to generally include wall bases formed from vinyl (e.g. polyvinyl chloride or PVC), thermoplastic rubber (TPR), and other polymeric materials with similar properties.

Dioctyl phthalate (DOP) is believed to be commonly used by manufacturers of vinyl wall bases in amounts up to 30% to 40% by weight to impart sufficient flexibility to the polymeric compounds. However, it has recently been discovered that DOP plasticizers have a deleterious effect on the adhesiveness of polyacrylic adhesive. When vinyl wall bases or other similar polymeric protective and/or decorative structures are substantially free from DOP plasticizers or other substantially equivalent plasticizer materials which have such a deleterious effect, the use of polyacrylic adhesive to hold such structures to walls and other surfaces results in significantly improved adhesion as compared to typical thermoplastic wall bases which include DOP as a plasticizer. “Substantially free” of DOP is defined herein as from 0% to about 4% by weight DOP. The “substantially free” definition above may include weight percentages of greater than 4% DOP if such amounts do not exhibit significant deleterious effects on the desired adhesive characteristics of the adhesive tape, thereby allowing the wall base to remain substantially adhered to the wall for the expected useful life of the vinyl wall base. During experimentation, wall bases that were substantially free of DOP plasticizers were observed to provide far superior strength and longer lasting attachment of the wall base to a wall as compared to typical vinyl wall bases containing typical amounts of DOP plasticizer used with a polyacrylic adhesive.

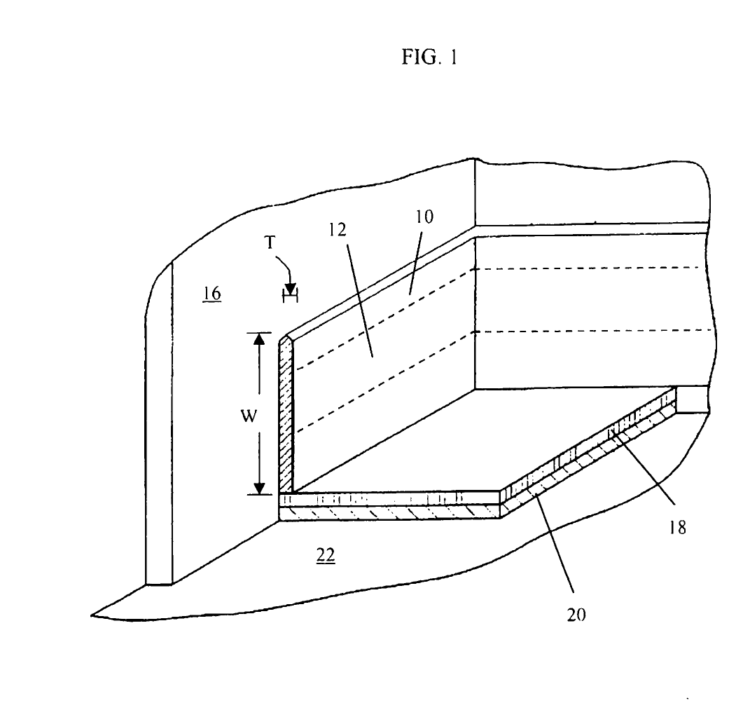

One embodiment of the invention includes a protective structure in the form of a vinyl wall base 10, as shown in FIG. 1. The wall base 10 has a generally wide, thin configuration that is substantially planar when laid on a substantially flat surface or applied to a substantially flat surface. The wall base 10 may be provided as an elongate strip of a PVC compound which is substantially free from DOP plasticizer. In another embodiment, the wall base 10 may be provided as an elongate strip of thermoplastic rubber (TPR). In yet another embodiment, the wall base may be provided as an elongate strip of material including both PVC and TPR. The wall base typically has a width W of from about 3 inches to about 6 inches, more typically about 4 inches, and has a length substantially corresponding to the length of the wall or walls on which the wall base will be installed. The length of the wall base may conveniently be adjusted by, for example, cutting or other adjustment techniques known to persons having ordinary skill in the art. The thicknesses T of protective structures such as wall base 10 typically range from about 7×10⁻² inches to about 1.25×10⁻¹ inches. Such structures may be manufactured by an extrusion or molding process or other processes known to persons having ordinary skill in the art. One example of material that may be used to make a protective structure such as wall base 10 is the thermoplastic compound presently offered commercially under the tradename Geon® A80G0 or Geon® D9501 NATURAL by PolyOne Corporation of Ohio.

It will be understood that while the wall base 10 may be provided in one continuous length, a plurality of smaller segments may be placed end-to-end or one above the other to provide the desired coverage along one or more walls. The wall base 10 may be used with any type of flooring known to those skilled in the art including carpet, tile, linoleum, wood, and concrete.

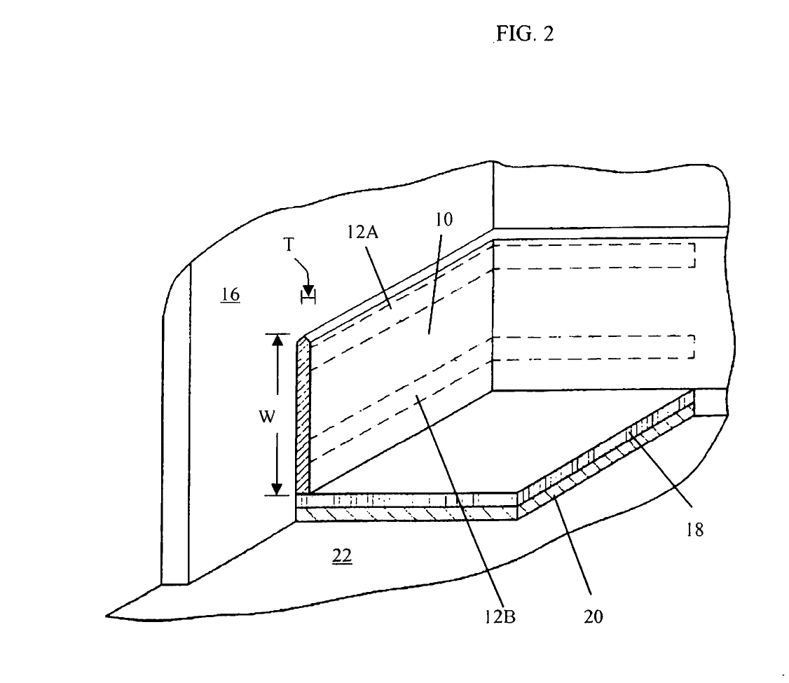

At least one strip of adhesive tape 12 for installing the wall base 10 along the lowermost portion of one or more substantially vertical walls is adhered to the backside of the wall base surface. As shown in FIG. 2, the adhesive strip of tape 12 may be provided by two continuous strips of double sided adhesive tape (12A and 12B) each preferably having a length corresponding to the length of the wall base 10. For a wall base having a width of 4 inches, the adhesive strips each would typically have a width S of from about ¼ inch to about 2 inches, preferably about 1 inch. The adhesive strips of tape are preferably of uniform width and thickness. In other alternate embodiments, more than two strips of adhesive tape may be used. In further alternate embodiments, the adhesive strip may not be continuous, but may have a broken configuration along the length of the wall base.

A preferred double-sided adhesive tape is a double-sided polyacrylic adhesive tape available under the tradename STIX TAPE from Base King, LLC of Dalton, Ga. The adhesive strips 12 may be applied to the backside surface of the wall base by hand or machine using known techniques and equipment for applying double sided adhesive tape to roll or sheet material.

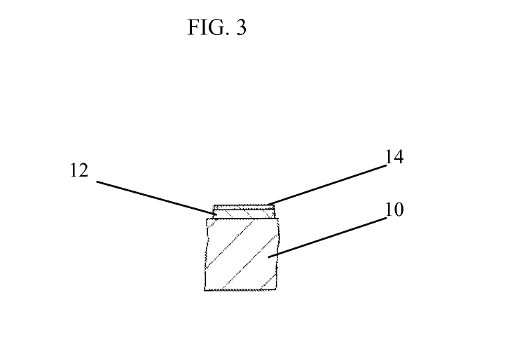

One side of the adhesive strip is adhesively secured to the backside of the wall base and the other side of the adhesive strip is preferably covered with at least one pull-away release liner strip 14, as shown in FIG. 3. The release liners are preferably removed prior to or during the securing of the wall base to a wall surface as explained below. The release liners, for example, may be silicon-coated unbleached kraft paper having a basis weight of about 3×10⁻² to about 4×10⁻² lbs/ft².

The wall base 10 is preferably secured along the lower part of a wall 16 after a flooring material (e.g., carpeting 18 and associated padding 20) has been installed along a subfloor 22. The wall base 10 may be applied from a roll thereof by pulling off a first short length of the wall base and removing the release liner to expose the adhesive portion of the adhesive strip. The wall base 10 with the exposed adhesive portion of the adhesive strip 12 is positioned at the desired location against the wall 16 at a starting point such as, for example, at the corner between two walls with the lower edge of the wall base 10 substantially at the wall-floor intersection. Slight hand pressure is preferably applied to initially press the adhesive strip 12 against the wall. The wall base 10 is then unrolled to the end of the wall under hand tension to stretch the wall base slightly. Slight hand pressure is preferably applied to the outer surface of the wall base during this process to secure the wall base 10 to the wall while the wall base 10 is unrolled. Adjustments may then be made to the position of the wall base 10 by hand to position the wall base 10 evenly along the wall 16 and firm pressure applied by hand or a suitable tool such as a roller or the like to finally fix the position of the wall base 10.

In a related embodiment, a vinyl wall base which is substantially free from dioctyl phthalate plasticizer with at least one adhesive strip adhered to the backside surface of the wall base for substantially adhering the wall base along the lowermost portion of one or more walls is provided as described above. In this embodiment a plasticizer is provided in the wall base to impart flexibility to the wall base. The plasticizer may include a phthalate other than DOP (or any substantially equivalent plasticizer material which exhibits deleterious effects on the adhesive qualities of adhesive tapes). Alternatively, the plasticizer may include (1) an adipate-based plasticizer such as Bis(2-ethylhexyl)adipate (DOA), Dimethyl adipate (DMAD), Monomethyl adipate (MMAD), Dioctyl adipate, other similar adipate-based plasticizers, or a combination thereof; (2) a trimellitate such as trimethyl trimellitate (TMTM), Tri-(2-ethylhexyl) trimellitate (TEHTM-MG) Tri-(n-octyl,n-decyl) trimellitate (ATM), Tri-(heptyl,nonyl) trimellitate (LTM), n-octyl trimellitate (OTM), other similar trimellitates, or a combination thereof; (3) maleates such as dibutyl maleate (DBM), Diisobutyl maleate (DIBM), other similar maleates, or a combination thereof; (4) sulfonamides such as N-ethyl toluene sulfonamide (o/p ETSA), N-(2-hydroxypropyl)benzene sulfonamide (HP BSA), N-(n-butyl)benzene sulfonamide (BBSA-NBBS), other similar sulfonamides or a combination thereof; (5) organophosphates such as tricresyl glycol dihexanoate, tributyl phosphate, other similar organophosphates, or a combination thereof; (6) glycols such as triethylene glycol dihexanoate, tetraethylene glycol diheptanoate, other similar glycols, or a combination thereof; and/or (7) sebacates, benzoates, epoxidized vegetable oils, alkyl citrates, nitrobenzene, carbon disulfide, β-naphthyl salicylate, other similar plasticizers, or a combination thereof.

In another related embodiment, a protective structure including at least one adhesive strip of tape for installing the protective structure along a surface and a thermoplastic planar molding which is substantially free from dioctyl phthalate plasticizer to maintain sufficient adhesion between the molding and a wall is provided. The adhesive strip of tape is adhered to a backside surface of the molding. The protective structure may be installed horizontally, vertically, or at an angle on a surface. For example, the protective structure may be installed as crown molding along an upper portion of a wall near a ceiling surface. The molding preferably has a length corresponding to the length of the surface or surfaces on which the protective structure will be installed. The length of the wall base may conveniently be adjusted by, for example, cutting or other adjustment techniques to persons having ordinary skill in the art. The thickness T of the polymeric material will typically range from about 7×10⁻² inches to about 1.25×10⁻¹ inches. In this embodiment, the plasticizer used to increase the flexibility of the molding may include non-DOP pthalates, adipate-based plasticizers, trimellitates, maleates, sebacates, berizoates, epoxidized vegetable oils, sulfonamides, organophosphates, glycols, alkyl citrates, other similar plasticizers, or a combination thereof. Such a wall base may be manufactured by an extrusion or molding process or other processes known to persons having ordinary skill in the art. One example of material that may be used to make a wall base as defined above is the thermoplastic compound presently offered commercially under the tradename Geons A80G0 or Geon® D9501 NATURAL by PolyOne Corporation of Ohio.

Other embodiments of the invention include methods including a method for protecting and/or decorating surfaces using a protective structure. This method includes the steps of providing a protective structure including a substantially planar polymeric member that is substantially free from dioctyl phthalate (DOP) and attaching the protective structure to a surface. In a related embodiment, the method also includes the step of adjusting the size of the protective structure by, for example, cutting the polymeric member. In a preferred embodiment, the protective structure that is provided includes at least one strip of adhesive tape adhered to a backside surface of the polymeric member. The at least one strip of adhesive tape preferably includes a pull-away release liner strip such as, for example, strip 14. In an embodiment that includes the provision of a protective structure that includes the pull away release liner strip, a method includes the step of removing the release liner strip before or during the step of attaching the protective structure to a surface.

The apparatus and methods described herein are preferably used in relation to indoor surface, and are preferably in the form of a vinyl wall base. However, other uses on other surfaces (including outdoor surfaces and surfaces other than at the base of a wall) are contemplated.

The foregoing description of preferred embodiments for this invention has been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A protective structure for protecting a surface, the protective structure comprising a substantially planar elongate polymeric member with at least one adhesive strip on a backside surface thereof for adhering the polymeric member to a portion of one or more surfaces, wherein the polymeric member is substantially free of dioctyl phthalate (DOP).

2. The protective structure of claim 1 wherein the at least one adhesive strip comprises at least one strip of adhesive tape including a first side and a second side, the first side of the adhesive tape being attached to the backside surface of the polymeric member and a pull away release liner strip covering at least a portion of the second side of the adhesive tape.

3. The protective structure of claim 2, wherein the strip of adhesive tape extends substantially continuously from a first end of the polymeric member to a second end of the polymeric member.

4. The protective structure of claim 1, wherein the adhesive strip is discontinuous.

5. The protective structure of claim 1, wherein the adhesive strip consists essentially of an integral layer of adhesive with a release liner attached thereto.

6. The protective structure of claim 1 wherein the polymeric member contains less than about 4% dioctyl phthalate (DOP) by weight.

7. The protective structure of claim 1 wherein the polymeric member comprises a substantially continuous vinyl wall base.

8. The protective structure of claim 2 wherein the at least one strip of adhesive tape comprises polyacrylic adhesive tape.

9. The protective structure of claim 1 wherein the polymeric member comprises a vinyl wall base containing one or more plasticizers.

10. The protective structure of claim 9 wherein the one or more plasticizers are selected from the group consisting of non-DOP pthalates, adipate-based plasticizers, trimellitates, maleates, sebacates, benzoates, epoxidized vegetable oils, sulfonamides, organophosphates, glycols, alkyl citrates, or a combination thereof.

11. A protective structure comprising a substantially planar elongate polymeric member and at least one strip of polyacrylic adhesive tape adhered to a backside surface of the polymeric member, the strip of adhesive tape dimensioned to effectively attach the protective structure to a portion of one or more surfaces, wherein the elongate polymeric member is substantially free of dioctyl phthalate (DOP).

12. The protective structure of claim 11 wherein the elongate polymeric member comprises a plastic wall base for adhering to the base area of a generally vertical wall adjacent the intersection of a lower edge of the wall with a floor, step, or other generally horizontal surface extending therefrom to protect the base area from damage caused by contact of items or materials therewith.

13. The protective structure of claim 12 wherein the composition of the wall base further comprises polyvinyl chloride (PVC).

14. The protective structure of claim 12 wherein the composition of the wall base further comprises thermoplastic rubber (TPR).

15. The protective structure of claim 11 wherein the polymeric member comprises less than about 4% dioctyl phthalate (DOP) by weight.

16. The protective structure of claim 11 wherein the wall base has a width of from about three inches to about six inches and a thickness of from about 7×10⁻² inches to about 1.25×10⁻¹ inches.

17. The protective structure of claim 11 wherein the elongate polymeric member includes at least one plasticizer.

18. The protective structure of claim 15 wherein the at least one plasticizer is selected from the group consisting of non-DOP pthalates, adipate-based plasticizers, trimellitates, maleates, sebacates, benzoates, epoxidized vegetable oils, sulfonamides, organophosphates, glycols, alkyl citrates, or a combination thereof.

19. A method for protecting a base area from damage caused by contact of items or materials therewith, the method comprising the steps of:
(a) providing an elongate protective wall base comprising a substantially planar polymeric member that is substantially free of dioctyl phthalate (DOP); and
(b) adhesively attaching the wall base to the base area of the wall by adhesive interposed between at least part of the wall base and at least part of the base area of the wall.

20. The method of claim 19 wherein the adhesive is provided by at least one strip of polyacrylic adhesive tape attached between a backside surface of the wall base and the base area of the wall.
